(19) United States
(12) Patent Application Publication
(10) Pub. No.: US 2006/0096776 A1
(43) Pub. Date: May 11, 2006

(54) Gripping means for a signal line and signal line

(76) Inventor: Mathijs Theodorus Wilhelmus Van De Ven, Asten-Heusden (NL)

Correspondence Address: William H Logsdon;Webb Ziesenheim Logsdon Orkin & Hanson, 436 Seventh Avenue, 700 Koppers Building, Pittsburgh, PA, 15219-1818, US

(21) Appl. No.: 10/519,601

(22) PCT Filed: Jul. 4, 2003
(86) PCT No.: PCT/NL03/00496

§ 371 Date: Sep. 16, 2005

(30) Foreign Application Priority Data
Jul. 4, 2002 (NL) 1020997

(51) Int. Cl. H01B 7/00

(52) U.S. Cl. 174/111

(57) ABSTRACT

The invention relates to a gripping means for a signal line, which signal line is embodied such that the signal transmitted through the line can be influenced by loads exerted externally on the cable, which gripping means comprise at least one rigid component adapted to grip the sleeve of the signal line, wherein the gripping means also comprise a spring element engaging on the rigid component to remove the load of the rigid component from the signal line. The invention also relates to a signal line embodied such that a signal transmitted through the line can be influenced by loads exerted externally on the cable.

The invention relates to gripping means for a signal line according to the preamble of claim 1. The invention also relates to a signal line according to the preamble of claim 14.

The use of lines to carry signals, by transmitting a signal therethrough and by then measuring this signal in order to thus detect whether a change has occurred in the external load (particularly pressure) of the line, is known. Line sensors of this type make use of changes in the wavelength of a signal transported through a line as a consequence of external loads exerted upon the line during the signal transport. Reference is made here to the International patent application PCT/NL97/00693, which describes a light-transmitting cable with which an external load can be detected. In addition to the use of for example glass fibre or synthetic fibre for transporting-light of the visible spectrum (for example 180-800 nm), it is also possible in this context to envisage an even broader spectrum of electromagnetic radiation in combination with lines adapted for passage of such radiation. There are no restrictions in respect of the minimal or maximal diameter of the line. A drawback of the existing lines for this application is that they are usually wrapped around a core (tube) with crossing patterns, whereby the greatest sensitivity occurs at the positions where the cable crosses. A significant drawback is the relatively voluminous and expensive structure that must therefore be arranged (usually built in) at a location to be monitored. An additional drawback of such a structure is that the maximum length of a sensor (the length to be monitored) is considerably decreased due to the structure.

The present invention has for its object to provide a solution with which the sensitivity of a signal-carrying line can be increased in simple manner and with which the above stated drawbacks of the prior art can be avoided.

To this end the invention provides gripping means of the type stated in the preamble with the feature that the gripping means also comprise a spring element engaging on the rigid component to remove the load of the rigid component from the signal line. The phrase ‘removing the load’ is here understood to mean at least partially removing the load exerted by the rigid component on the signal line, at least in a situation where the rigid component is not externally loaded, or only loaded to a limited extent. In an unloaded situation of the signal line a signal is thus not influenced, or less so, by the at least one more rigid component. An important advantage hereof is that the signal line can have a greater length than a comparable signal line with comparable peripheral equipment according to the prior art. Because the signal will not be distorted (or at least less so than according to the prior art), the reliability of an application of the signal line is also increased relative to the existing applications. The spring element is preferably adapted here to exert a biasing force on the rigid component and directed away from the signal line when the rigid component is displaced to the signal line, so that the rigid component is pushed away from the signal line.

European patent application EP 0 419 267 describes an optical sensor control system that makes use of an optical cable sensitive to an internal pressure P. The invention focuses more specifically on the signals utilized in such a system. Serrated (corrugated) elements are also shown whereby external pressure can be transmitted to the optical cable. There is no reference to means for forcing apart these serrated elements in the unloaded state thereof.

The spring element can be manufactured from a flexible material, such as for instance a flexible plastic or (synthetic) rubber. On the other hand it is also possible to use other types of spring, such as for example a metal spring. In a specific preferred variant, the spring element is embodied as a resilient sleeve in which at least one rigid component is placed. When it supports on a form-retaining (hard) object, the resilient sleeve will function as a spring element. In another preferred variant the spring element is placed between two rigid components to be pushed apart by the spring element, wherein the signal line can then be placed between the components. With such a ‘switch’, the rigid components will be pushed apart in an unloaded situation such that they will exert no load (or only a limited one) on the signal line.

If the gripping means are provided with connecting means, an optionally releasable coupling can be realized between the gripping means and the signal line. The advantage of such a coupling is that the relative orientation of gripping means and signal line is thus made manageable, and thereby also the effect of the gripping means on the signal line.

The rigid component preferably has a hardness of between 10 and 100 Shore (for example hardness Shore A or Shore D), even more preferably a hardness between 25 and 75 Shore. A for instance more or less sharp contact edge of the rigid component that lies against the signal line will form a location where the sensitivity of the signal line is great. Another advantage is that a signal-carrying cable can be built in very easily because of the present invention; a construction that is voluminous and difficult to assemble is after all unnecessary. It will be apparent that this also results in a more economical application of a pressure-sensitive signal line. Yet another advantage is that the locations where the line is most sensitive can be determined very precisely.

In an advantageous embodiment variant of the gripping means, the edge of the rigid component connects to the spring element, preferably a component with a hardness less than 60 Shore, even more preferably less than 40 Shore (for example hardness Shore A or Shore D). By way of this embodiment variant it becomes possible for instance to combine a plurality of rigid components with each other with softer components therebetween; the gripping means can therefore comprise a large number of edges which result in increased sensitivity.

In yet another preferred variant, the gripping means are positioned such that an edge of the rigid component is at least substantially at right angles to the centre line of the signal line. This results in a high degree of sensitivity of the signal line.

The gripping means can be releasable from the signal line such that they can be connected to the signal line at a position where sensitivity is desired. It is also possible to change the locations with relatively high sensitivity by displacing the gripping means. On the other hand it is also possible for the gripping means to be combined, at least partially, with a sleeve of the signal line. An example hereof is the integration of the at least one rigid component with the sleeve of the signal line. In yet another preferred variant, the gripping means are provided with at least one holding member for coupling to an object to be monitored. Here must be envisaged for instance openings in which tiles can be placed, such that contact with the tiles is transmitted by means of the gripping means to the signal line. The holding member will herein usually be located on the side of the gripping means remote from the side of the gripping means that is connectable to the signal line.

The present invention also provides a signal line of the type mentioned in the preamble, characterized in that the signal line is provided with at least one of the gripping means as described above. In addition to utilizing separate gripping means, it is also possible within the scope of the present invention to directly provide the signal line with the gripping means. It thus becomes possible for instance to use a finished signal line, i.e. a signal line with gripping means already placed or incorporated. It is desirable here that the signal line passes in a smooth line through the gripping means. In the unloaded situation of the gripping means such a relationship of signal line and gripping means does not impede passage of the signal at all. The maximum length of the signal-carrying line is not therefore limited by the gripping means.

In order to prevent for instance undesired disconnection of the gripping means from the signal line, the gripping means can be connected non-releasably to the signal line. This is the case for instance when the gripping means form part of a sleeve enclosing the signal line. This embodiment variant also makes it possible to construct a sensitive signal line in very advantageous manner.

The invention also provides an assembly manufactured from a flexible material provided with gripping means for a signal line as described above, wherein the at least one rigid component is assembled with the flexible structural element. Instead of combining the gripping elements with the signal line, it is also possible to combine them with the structural element in which the signal line is placed. An additional advantage of such a structural element is that it enables an easy coupling to the signal line of a construction in which detection is desired. Particularly envisaged here is a structural element in the form of a flexible sealing element, such as a rubber bumper, a rubber seal and so on.

The present invention will be further elucidated on the basis of the non-limitative embodiments shown in the following figures, in which:

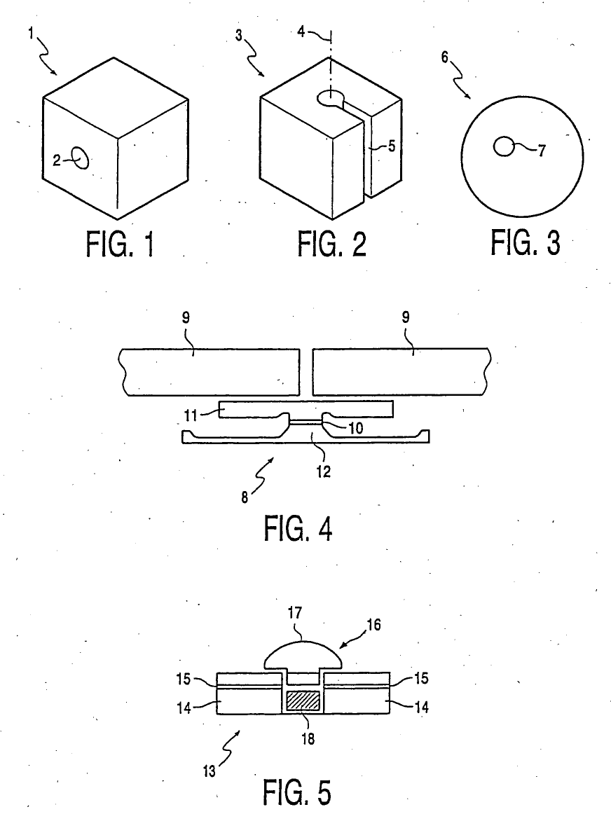

FIG. 1 shows a view of a first variant of a rigid component forming part of a gripping means according to the invention,

FIG. 2 shows a view of a second variant of a rigid component forming part of a gripping means according to the invention,

FIG. 3 is a view of a third variant of a rigid component forming part of gripping means according to the invention,

FIG. 4 shows a cross-section through a gripping means according to the invention,

FIG. 5 shows a cross-section through a second variant of a gripping means according to the invention,

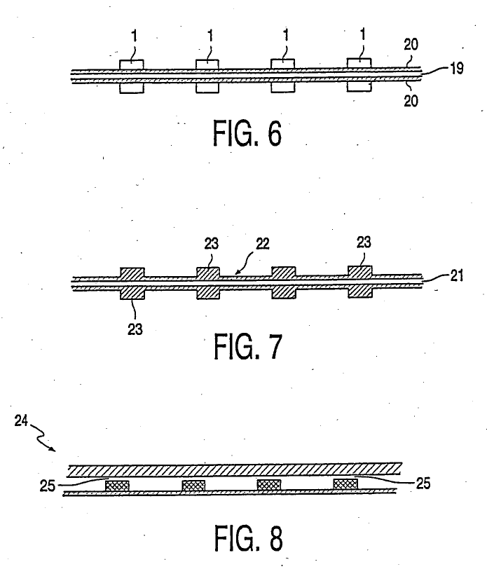

FIG. 6 shows a cross-section through a signal line according to the invention,

FIG. 7 shows a cross-section through a second variant of a signal line according to the invention, and

FIG. 8 shows a cross-section through a third variant of a gripping means according to the invention.

FIG. 1 shows a rigid component 1 in a block form in which is arranged an opening 2 through which a signal line can be passed. For this purpose a line has to be pulled through opening 2. The rigid component 3 shown in FIG. 2 is likewise provided with a continuous opening 4 for receiving a line. A feed channel 5 connects onto opening 4 in this variant so that the rigid component 3 can be clicked onto a line in simple manner, at least in the case the dimensions of the line and rigid component 3 are adapted to each other. FIG. 3 shows yet another variant of a rigid component 6 in the form of a ball with a central opening 7 for receiving a signal line. When they grip onto a signal line, each of the rigid components 1, 3, 6 can be embedded in a flexible sleeve not shown in these figures, which flexible sleeve can then function as a spring element. When a rigid component 1, 3, 6 is loaded, it will be pressed from a starting position into the resilient sleeve, wherein a local load will simultaneously be exerted on the signal line. When the load has disappeared, rigid components 1, 3, 6 are urged back to the starting position again by the resilient sleeve.

The gripping means 8 shown in FIG. 4 can for instance be applied to support tiles 9. Gripping means 8 is provided with an opening 10 for receiving a signal line (not shown). In the case of an uneven load on the tiles 9, the upper flat part 11 of gripping means 8 will rotate. The consequence is that an upright part 12 which supports the upper flat part 11 will also deform. Deformation of the upright part 11 has an effect on the signal line fed through opening 10. In this variant of the gripping means, the rigid component is formed by the material surrounding the opening 10, while the spring element is formed by upright part 12. The rigid component and spring element 12 are thus made from a single material part; the different characteristics are not obtained in this embodiment by using different types of material but rather by the design of the material, which results in the rigid component around opening 10 and the spring element 12.

FIG. 5 shows yet another gripping means 13 in the form of a ‘push button’. A holder 14 is provided with a receiving space 15 for a signal line; holder 14 forms a rigid component. Also lying against the signal line is a push button 16 that has a rounded head 17 that protrudes above holder 14; push button 16 also forms a rigid component. In order to bring the line into a non-deformed state in an unloaded position of the push button 16, there is placed in gripping element 13 a resilient element 18 with which in an unloaded position the push button 16 is pressed outward (out of holder 14) such that a signal line (not shown) placed in receiving space 15 is not loaded, or only loaded to a very limited extent, by holder 14 and/or push button 16.

FIG. 6 shows a signal line 19, for example in the form of a glass fibre cable 19, which is provided with a protective sleeve 20. Sleeve 20 is provided on the outside with gripping elements 1, 3 in the form of rigid components as already shown in FIGS. 1 and 2. The signal line 21 shown in FIG. 7 is provided with a sleeve 22 into which rigid components 23 are integrated in the form of thickened sleeve parts. Although this variant is also conceivable, it is recommended that the thickened sleeve parts are embodied separately from the sleeve (and optionally assembled with the sleeve later); it is then after all more a case of an edge gripping the signal line. Depending on the circumstances however, the variant of the signal line as shown in FIG. 7 can also be envisaged, for instance if sleeve 22 takes a relatively thin form at the non-thickened positions. For proper operation of signal lines 19, 21 it is desirable that they be supported in resilient manner. This is for instance possible by placing signal lines 19, 21 on a resilient material layer or by arranging a sleeve manufactured from a resilient material around the illustrated signal lines 19, 21.

Finally, FIG. 8 shows a gripping means 24 in the form of a rubber seal, for instance for a door, made of a flexible material in which is arranged a passage 25 for a signal line. More rigid gripping elements 26 are integrated into structural element 24 so as to increase the sensitivity of a signal line placed in structural element 24. As a variant it is also possible for the more rigid gripping elements to be manufactured from the material of which the rubber seal is made, wherein a greater rigidity is imparted to gripping elements 26 solely due to the shape thereof.

1-18. (canceled)

19. Gripping means for a signal line, which signal line is embodied such that the signal that is fed through the line can be influenced by loads exerted externally on the cable, which gripping means comprise at least one rigid component adapted to grip on the sleeve of the signal line,
wherein the gripping means also comprise a spring element engaging on the rigid component to remove the load of the rigid component from the signal line.

20. The gripping means as claimed in claim 19, wherein the spring element is adapted to exert a biasing force on the rigid component and directed away from the signal line when the rigid component is displaced to the signal line.

21. The gripping means as claimed in claim 19, wherein the spring element is manufactured from a flexible material.

22. The gripping means as claimed in claim 19, wherein the spring element is embodied as a resilient sleeve in which at least one rigid component is placed.

23. The gripping means as claimed in claim 19, wherein the spring element is disposed between two rigid components to be pushed apart by the spring element, between which components the signal line is placed.

24. The gripping means as claimed in claim 19, wherein the gripping means are provided with connecting means for fastening the gripping means to the signal line.

25. The gripping means as claimed in claim 19, wherein the rigid component has a hardness between 10 and 100 Shore, preferably between 25 and 75 Shore.

26. The gripping means as claimed in claim 19, wherein the spring element has a hardness less than 60 Shore, preferably less than 40 Shore.

27. The gripping means as claimed in claim 19, wherein the gripping means are positioned such that an edge of the rigid component is positioned at least substantially at right angles to the centre line of the signal line.

28. The gripping means as claimed in claim 19, wherein the gripping means are releasable from the signal line.

29. The gripping means as claimed in claim 19, wherein the gripping means are at least partially combined with a sleeve of the signal line.

30. The gripping means as claimed in claim 19, wherein the gripping means are provided with at least one holding member for coupling to an object to be monitored.

31. The gripping means as claimed in claim 30, wherein the holding member is located on the side of the gripping means remote from the side of the gripping means that is connectable to the signal line.

32. A signal line embodied such that a signal that is transmitted through the line can be influenced by loads exerted externally on the cable, wherein the signal line is provided with at least one of the gripping means as claimed in claim 19.

33. The signal line as claimed in claim 32, wherein the signal line passes in a smooth line through the gripping means.

34. The signal line as claimed in claim 32, wherein the gripping means are connected in at least a partially non-releasable manner to the signal line.

35. The signal line as claimed in claim 32, wherein the rigid component forms part of a sleeve enclosing the signal line.

36. The signal line as claimed in claim 32, wherein the signal line is embodied as a flexible sealing element.
